(19) United States
(12) Patent Application Publication
(10) Pub. No.: US 2026/0011708 A1
(43) Pub. Date: Jan. 8, 2026

(54) SECONDARY BATTERY ELECTRODE PLATE MANUFACTURING APPARATUS INCLUDING DIE PARALLELISM MONITORING DEVICE AND SECONDARY BATTERY ELECTRODE PLATE MANUFACTURING METHOD

(71) Applicant: Samsung SDI Co., Ltd., Yongin-si (KR)

(72) Inventors: Seungjun Lee, Yongin-si (KR); Yongseung SHIN, Yongin-si (KR); Hee Taek LIM, Yongin-si (KR); Sungkyun Jung, Yongin-si (KR)

(21) Appl. No.: 19/091,710

(22) Filed: Mar. 26, 2025

(30) Foreign Application Priority Data
Jul. 4, 2024 (KR) 10-2024-0088451

(51) Int. Cl. H01M 4/04; B21D 43/02; H01M 4/1391

(52) U.S. Cl. CPC H01M 4/04; B21D 43/021; H01M 4/1391

(57) ABSTRACT

A secondary battery electrode plate manufacturing apparatus includes: a distance measurement sensor installed in a die and configured to output a sensor output value; a parallelism calculation unit configured to convert the sensor output value into a distance value to determine parallelism of the die; and a punch insert amount calculation unit configured to calculate a punch insert amount by using the converted distance value.

### CROSS-REFERENCE TO RELATED APPLICATION

The present application claims priority to and the benefit of Korean Patent Application No. 10-2024-0088451, filed on Jul. 4, 2024, in the Korean Intellectual Property Office, the entire disclosure of which is incorporated herein by reference.

### BACKGROUND

### 1. Field

Aspects of embodiments of the present disclosure relate to a secondary battery electrode plate manufacturing apparatus and a secondary battery electrode plate manufacturing method, and more particularly, to monitoring parallelism of a die used for notching or cutting an electrode plate.

### 2. Description of the Related Art

Different from primary batteries, which are not designed to be recharged, secondary batteries are batteries that are designed to be charged and discharged. Generally, a secondary battery includes an electrode assembly including a positive electrode plate, a negative electrode plate, and a separator.

The positive or negative electrode plate may be manufactured by coating, rolling, slitting, and notching processes. In a notching process, an electrode plate is manufactured by cutting unnecessary portions of a substrate using a shear die and forming electrode tabs. A die includes a pair of punches and a pair of dies for forming a bottom and a tab of a substrate and is installed in press equipment for operating the punches and dies.

Conventionally, a method for measuring parallelism of a die involves a worker manually measuring in a stationary state. When parallelism is measured by using a contact sensor during punching, the sensor may be damaged. Conventionally, a pneumatic cylinder-type integrated linear variable differential transformer (LVDT) is installed in equipment to automatically perform measurement in a stationary state. However, in the case of a die, a measurement space thereof is small, which makes it difficult to install an LVDT, and thus, measurement is still performed manually. In addition, because a worker must manually insert a dial gauge to perform measurement, it takes time to perform the measurement and there is a possibility of human error. Moreover, because equipment should be stopped to perform measurement, real time parallelism cannot be known during punching, and when punching continues while parallelism is degraded, the die may be damaged and electrode quality may be adversely affected.

The above information disclosed in this Background section is for enhancement of understanding of the background of the present disclosure, and therefore, it may contain information that does not constitute a related (or prior) art.

### SUMMARY

Embodiments of the present disclosure provide a method of automatically monitoring parallelism of a die in real time without manual work being performed by a worker.

According to an embodiment of the present disclosure, a secondary battery electrode manufacture apparatus includes a distance measurement sensor installed in a die and configured to output a sensor output value, a parallelism calculation unit configured to convert the sensor output value into a distance value to determine parallelism of the die, and a punch insert amount calculation unit configured to calculate a punch insert amount by using the converted distance value.

According to another embodiment of the present disclosure, a secondary battery electrode plate manufacturing method includes a parallelism calculation operation including converting an output value of a distance measurement sensor installed in a die into a distance value to check parallelism of the die and a punch insert amount calculation operation including calculating a punch insert amount by using the converted distance value.

Aspects and features of the present disclosure are not limited to those described above, and other aspects and features not specifically mentioned herein will be clearly understood by those skilled in the art from the description of the present disclosure below.

### BRIEF DESCRIPTION OF THE DRAWINGS

The following drawings attached to the present specification illustrate embodiments of the present disclosure and further describe aspects and features of the present disclosure together with the detailed description of the present disclosure. Thus, the present disclosure should not be construed as being limited to the drawings, in which:

FIG. 1 schematically illustrates an electrode assembly of a secondary battery;

FIG. 2 schematically illustrates a pouch-type secondary battery;

FIG. 3 is a cross-sectional view of a cylindrical secondary battery;

FIG. 4 is a cross-sectional view of a prismatic secondary battery;

FIG. 5 illustrates an electrode plate before and after notching by a die;

FIG. 6A is a schematic conceptual view of a shear die according to some embodiments of the present disclosure;

FIG. 6B is a perspective view of press equipment on which a punch and the die shown in FIG. 6A are installed.

FIG. 7A is a vertical cross-sectional view of the press equipment shown in FIG. 6B.

FIG. 7B illustrates a deviation in parallelism of press equipment on a punch and a die;

FIG. 8 is a schematic block diagram of a die parallelism monitoring device according to some embodiments of the present disclosure;

FIG. 9A is a vertical cross-sectional view illustrating a distance measurement sensor installed in a die;

FIG. 9B is a plan view of a die holder;

FIG. 10A is a current-distance graph and equation for converting a current value obtained by a sensor into a distance value;

FIG. 10B is a flow chart describing a method of obtaining a current-distance graph or equation;

FIGS. 11A and 11B are schematic views for describing the calculation of a punch insert amount; and

FIG. 12 illustrates a correction mechanism installed in a die.

### DETAILED DESCRIPTION

Hereinafter, embodiments of the present disclosure will be described, in detail, with reference to the accompanying drawings. The terms or words used in the present specification and claims should not be narrowly interpreted according to their general or dictionary meanings but should be interpreted as having meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some embodiments of the present disclosure and do not represent all of the aspects, features, and embodiments of the present disclosure. Accordingly, it should be understood that there may be various equivalents and modifications that can replace or modify one or more embodiments or features therein described herein at the time of filing this application.

It will be understood that if an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, if a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” if describing embodiments of the present disclosure relates to “one or more embodiments of the present disclosure.” Expressions, such as “at least one of” and “any one of,” if preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” if used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same.” Thus, the phrase “substantially the same” may include a case having a deviation that is considered low in the art, for example, a deviation of 5% or less. In addition, if a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may contact the upper (or lower) surface of the element, and another element may also be interposed between the element and the arbitrary element located on (or under) the element.

In addition, it will be understood that if a component is referred to as being “linked,” “coupled,” or “connected” to another component, the elements may be directly “coupled,” “linked” or “connected” to each other, or another component may be “interposed” between the components.”

Throughout the specification, if “A and/or B” is stated, it means A, B or A and B, unless otherwise stated. That is, “and/or” includes any or all combinations of a plurality of items enumerated. When “C to D” is stated, it means C or more and D or less, unless otherwise specified.

The parallelism calculation unit, punch insert amount calculation unit, and/or any other relevant devices, units, or components according to embodiments of the present disclosure described herein may be implemented utilizing any suitable hardware, firmware (e.g., an application-specific integrated circuit), software, and/or a suitable combination of software, firmware, and hardware. For example, the various components of the units may be formed on one integrated circuit (IC) chip or on separate IC chips. Further, the various components of the units may be implemented on a flexible printed circuit film, a tape carrier package (TCP), a printed circuit board (PCB), or formed on a same substrate as the units. Further, the various components of the units may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device or the functionality of a particular computing device may be distributed across one or more other computing devices without departing from the scope of the exemplary embodiments of the present disclosure.

The terminology used herein is for the purpose of describing embodiments of the present disclosure and is not intended to limit the present disclosure.

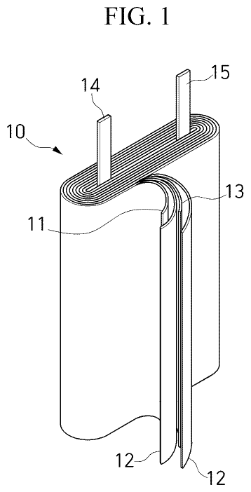

FIG. 1 shows an electrode assembly of a secondary battery.

Referring to FIG. 1, an electrode assembly 10 may be formed by winding or stacking a stack of a first electrode plate 11, a separator 12, and a second electrode plate 13, each of which are formed as thin plates or films. When the electrode assembly 10 is a wound stack, a winding axis may be parallel to a longitudinal direction of a case. In other embodiments, the electrode assembly 10 may be a stack type electrode assembly rather than a winding type electrode assembly, but the shape of the electrode assembly 10 is not limited in the present disclosure. In addition, the electrode assembly 10 may be a Z-stack electrode assembly in which a positive electrode plate and a negative electrode plate are inserted into both sides (e.g., opposite sides) of a separator, which is then bent (or folded) into a Z-stack. In addition, one or more electrode assemblies may be stacked (e.g., arranged) such that long sides of the electrode assemblies are adjacent to each other and accommodated in a case, and the number of electrode assemblies in a case is not limited in the present disclosure. The first electrode plate 11 of the electrode assembly may act as a negative electrode, and the second electrode plate 13 may act as a positive electrode. Of course, the reverse is also possible.

The first electrode plate 11 may be formed by applying (e.g., coating or depositing) a first electrode active material, such as graphite or carbon, onto a first electrode substrate formed of a metal foil, such as copper, a copper alloy, nickel, or a nickel alloy. The first electrode plate 11 may include a first electrode tab 14 (e.g., a first uncoated portion), which is a region to which the first electrode active material is not applied. The first electrode tab 14 may be connected to an external first terminal. In some embodiments, when the first electrode plate 11 is manufactured, the first electrode tab 14 may be formed by being cut in advance to protrude to (or protrude from) one side of the electrode assembly 10, or the first electrode tab 14 may protrude to one side of the electrode assembly 10 more than (e.g., farther than or beyond) the separator 12 without being separately cut.

The second electrode plate 13 may be formed by applying (e.g., coating or depositing) a second electrode active material, such as a transition metal oxide, onto a second electrode substrate formed of a metal foil, such as aluminum or an aluminum alloy. The second electrode plate 13 may include a second electrode tab 15 (e.g., a second uncoated portion), which is a region to which the second electrode active material is not applied. The second electrode tab 15 may be connected to an external second terminal. In some embodiments, the second electrode tab 15 may be formed by being cut in advance to protrude to the other side (e.g., the opposite side) of the electrode assembly 10 when the second electrode plate 13 is manufactured, or the second electrode plate 13 may protrude to the other side of the electrode assembly more than (e.g., farther than or beyond) the separator 12 without being separately cut.

The separator 12 prevents a short-circuit between the first electrode plate 11 and the second electrode plate 13 while allowing movement of lithium ions therebetween. The separator 12 may be made of, for example, a polyethylene film, a polypropylene film, a polyethylene-polypropylene film, or the like.

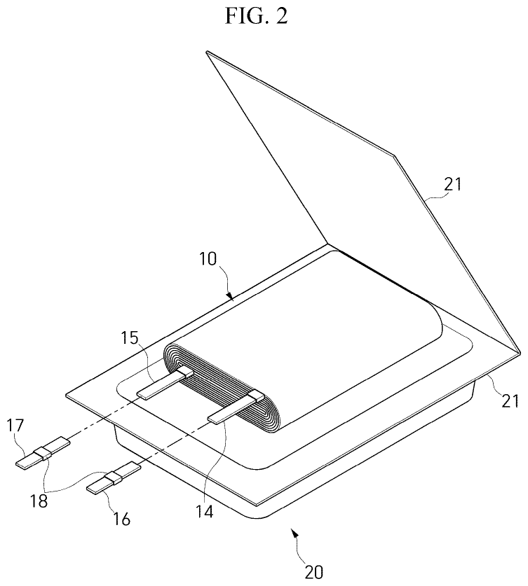

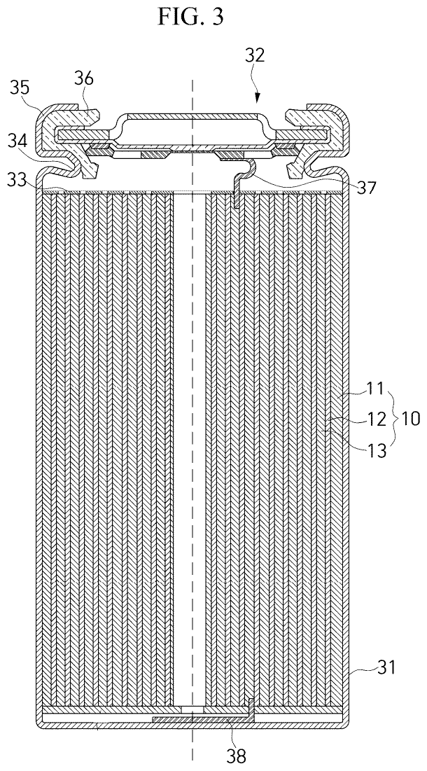

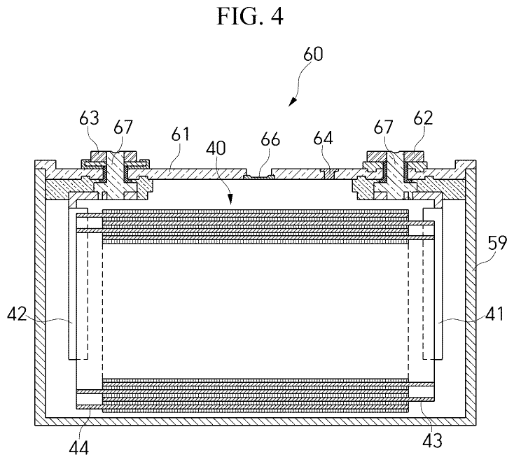

In some embodiments, the electrode assembly 10 may be accommodated in a case along with an electrolyte. In a pouch-type secondary battery, an electrode assembly 10 may be accommodated in a pouch made of flexible material (see, e.g., FIG. 2). In a cylindrical or prismatic secondary battery, an electrode assembly 10 may be accommodated in a cylindrical or prismatic metal casing (see, e.g., FIGS. 3 and 4).

Hereinafter, suitable materials that may be usable for the secondary battery according to embodiments of the present disclosure will be described.

As the positive electrode active material, a compound capable of reversibly intercalating/deintercalating lithium (e.g., a lithiated intercalation compound) may be used. For example, at least one of a composite oxide of lithium and a metal selected from cobalt, manganese, nickel, and combinations thereof may be used.

The composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following formulas may be used: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}CO_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<a<2); LiₐNi_{b}Co_{c}L¹_{d}GeO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}GbO₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D is 0, F, S, P, or a combination thereof; G is Al, Cr, Mn, Fe, Mg, La, Ce, Sr, V, or a combination thereof; and L¹ is Mn, Al, or a combination thereof.

A positive electrode for a lithium secondary battery may include a substrate and a positive electrode active material layer formed on the substrate. The positive electrode active material layer may include a positive electrode active material and may further include a binder and/or a conductive material.

The content of the positive electrode active material is in a range of about 90 wt % to about 99.5 wt % on the basis of 100 wt % of the positive electrode active material layer, and the content of the binder and the conductive material is in a range of about 0.5 wt % to about 5 wt %, respectively, on the basis of 100 wt % of the positive electrode active material layer.

The substrate may be aluminum (Al) but is not limited thereto.

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon-based negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si-based negative electrode active material or a Sn-based negative electrode active material may be used as the material capable of being doped and undoped with lithium. The Si-based negative electrode active material may be silicon, a silicon-carbon composite, SiOₓ (0<x<2), a Si-based alloy, or a combination thereof.

The silicon-carbon composite may be a composite of silicon and amorphous carbon. According to one embodiment, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a substrate and a negative electrode active material layer disposed on the substrate. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included.

As the negative electrode substrate, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move.

The non-aqueous organic solvent may be a carbonate-based, an ester-based, an ether-based, a ketone-based, an alcohol-based solvent, an aprotic solvent, and may be used alone or in combination of two or more.

In addition, when a carbonate-based solvent is used, a mixture of cyclic carbonate and chain carbonate may be used.

Depending on the type of lithium secondary battery, a separator may be present between the first electrode plate (e.g., the negative electrode) and the second electrode plate (e.g., the positive electrode). As the separator, polyethylene, polypropylene, polyvinylidene fluoride, or a multilayer film including two or more layers thereof may be used.

The separator may include a porous substrate and a coating layer including an organic material, an inorganic material, or a combination thereof on one or both surfaces of the porous substrate.

The organic material may include a polyvinylidene fluoride-based polymer or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combinations thereof but is not limited thereto.

The organic material and the inorganic material may be mixed in one coating layer or may be in the form of a coating layer including (or containing) an organic material and a coating layer including (or containing) an inorganic material that are stacked on each other.

FIG. 2 schematically illustrates a pouch-type secondary battery.

Referring to FIG. 2, the pouch-type secondary battery may include the electrode assembly 10 and a pouch 20 that accommodates the electrode assembly 10.

The first electrode tab 14 and the second electrode tab 15 of the electrode assembly 10 may be welded and electrically connected to an external first terminal lead 16 and an external second terminal lead 17, respectively. Tab films 18 for insulating the pouch 20 from the first and second terminal leads 16 and 17 may be attached to the first terminal lead 16 and the second terminal lead 17.

When the electrode assembly 10 is accommodated in the pouch 20, sealing portions 21 of the pouch 20 may be in contact with each other to seal the pouch 20, and in this case, the sealing may be achieved in a state in which the tab films 18 are interposed between the sealing portions 21. The sealing portion 21 of the pouch 20 may be made of a heat fusion material. Because the heat fusion material generally exhibits weak adhesion to metals, the sealing portion 21 may be fused to the pouch 20 by interposing the tab films 18 in the form of a thin film.

FIG. 3 is a cross-sectional view of a cylindrical secondary battery.

The cylindrical secondary battery includes an electrode assembly 10, a case 31 that accommodates the electrode assembly 10 and an electrolyte therein, a cap assembly 32 that is coupled to an opening in the case 31 to seal the case 31, and an insulating plate 33 that is positioned between the electrode assembly 10 and the cap assembly 32 inside the case 31.

The case 31 accommodates the electrode assembly 10 and the electrolyte and forms an exterior of a battery together with the cap assembly 32. The case 31 may include a body having an approximately cylindrical shape and a bottom. A beading portion 34 that is deformed inwardly may be positioned in the body of the case 31, and a crimping portion 35 that is bent inwardly may be positioned at an end portion of the body adjacent to the opening therein.

The beading portion 34 may prevent the electrode assembly 10 from moving inside the case 31 and may facilitate the seating of a gasket 36 and the cap assembly 32. The crimping portion 35 may firmly fix the cap assembly 32 by pressing an edge of the cap assembly 32 through the gasket 36. The case 31 may be made of, for example, nickel-plated iron.

The cap assembly 32 may be fixed inside the crimping portion 35 through the gasket 36 to seal the case 31. A first lead tab 37 drawn out from the electrode assembly 10 may be connected to the cap assembly 32, and a second lead tab 38 drawn out from the electrode assembly 10 may be electrically connected to the bottom of the case 31.

FIG. 4 illustrates an interior and cap assembly 60 of a prismatic secondary battery.

An electrode assembly 40 used in the prismatic secondary battery may also be formed by winding or stacking a first electrode plate, a separator, and a second electrode plate, which are formed in a plate shape or film shape, as shown in, for example, FIG. 1. If the electrode assembly 40 is a wound type, a winding axis thereof may be parallel to a longitudinal direction of a case 59. In addition, the electrode assembly 40 may be a stack type other than a wound type, but a shape of the electrode assembly 40 is not limited in the present disclosure. In addition, the electrode assembly 40 may be a Z-stack electrode assembly in which the first electrode plate and the second electrode plate are inserted into both sides of the separator, which is bent into a Z-stack. In addition, one or more electrode assemblies 40 may be stacked such that long side surfaces thereof are adjacent to each other and may be accommodated inside the case, and the number of electrode assemblies is not limited in the present disclosure. The first electrode plate of the electrode assembly 40 may act as a negative electrode, and the second electrode plate may act as a negative electrode, or vice versa.

A first electrode tab 43 of the first electrode plate and a second electrode tab 44 of the second electrode plate are each positioned on (or extend from) the electrode assembly 40. In some embodiments, the electrode assembly 40 may be accommodated in the case 59 together with an electrolyte.

The first electrode tab 43 and the second electrode tab 44 may be connected to a first current collector 41 and a second current collector 42 by welding, respectively. The first current collector 41 and the second current collector 42 are respectively connected to a first terminal 62 and the second terminal 63 through connection members 67. In some embodiments, outer peripheral surfaces of the connection member 67 may be threaded and may be connected to the first terminal 62 and the second terminal 63 by screw coupling. However, the present disclosure is not limited thereto, and the connection members 67 may be connected to the first terminal 62 and the second terminal 63 by, for example, riveting or welding.

A process of manufacturing an electrode plate (e.g., a first electrode plate 11 or a second electrode plate 13) of the electrode assembly (see, e.g., FIG. 1) will be briefly described.

A substrate for manufacturing the electrode plate may be a metal foil including aluminum (Al) (to form a positive electrode) or a metal foil including copper (Cu) or nickel (Ni) (to form a negative electrode). In a coating process, a slurry or powder-state mixture (e.g., an electrode material) prepared in advance is applied on a substrate to form a coating layer. Next, in a roll pressing process, the coated substrate may be rolled with rollers to manufacture a high-capacity and high-density secondary battery. The rolled substrate is cut in a length direction in a slitting process to separate individual electrode plates, which are then shaped into individual electrode plates in a notching process.

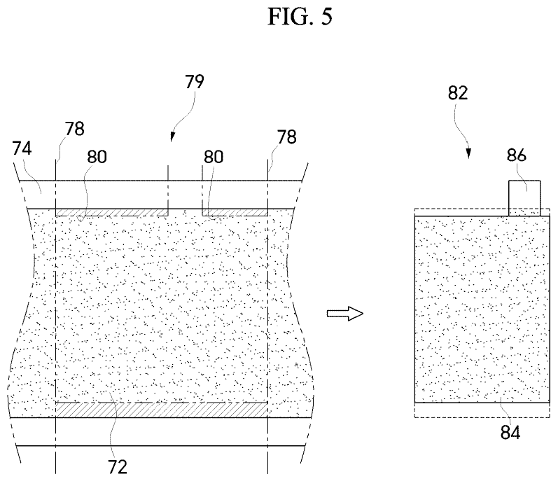

FIG. 5 shows illustrates a notching process and shows an electrode plate before and after notching.

In a notching process, a substrate 79 coated with an active material 72 in advance may be cut laterally along a lateral cutting line 78 and longitudinally along a longitudinal cutting line 80 by a notching unit. In addition, the notching unit may delete (e.g., remove) and clean up uncoated portions 74 and 76 along shaping lines 81. Finally, as shown on the right side of FIG. 5, a notched electrode plate 82 has an area 84 coated with a positive or negative electrode material and a tab 86, which is an uncoated area. The tab 86 is a portion to which a conductive member, such as a current collector or subplate, is to be bonded in a subsequent electrode assembly process.

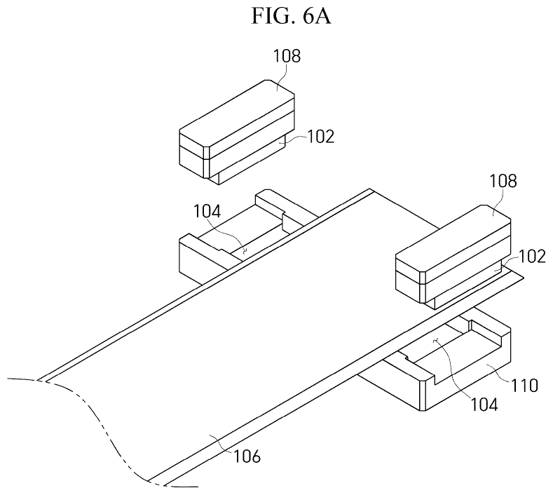

FIG. 6A is a schematic diagram of a notching die according to some embodiments of the present disclosure.

When an electrode plate 106 is loaded on a die 104, a punch 102 is lowered to punch the electrode plate 106 according to a designed shape to manufacture the electrode plate having a shape as shown in FIG. 5. The punch 102 may be supported on a punch plate 108, and the die 104 may be supported by a die plate 110.

The punch 102 and the die 104 may include a pair of punches and a pair of dies to concurrently (or simultaneously) punch and shape a tab 86 of the electrode plate and a side opposite thereto as shown in, for example, FIG. 5.

FIG. 6B is a perspective view of press equipment for operating the punch 102 and the die 104 shown in FIG. 6A. The mechanism shown in FIG. 6A is included in area I in FIG. 6B.

Press equipment 100 may include an upper part and a lower part.

The upper part may include a punch holder 112 to which the punch plate 108 is fixed and an upper slide 114 that supports the punch holder 112. The lower part may include a die holder 116 to which the die plate 110 is fixed and a lower slide 118 that supports the die holder 116. The upper part may move vertically relative to the lower part via (or along) a guide post 120.

The upper slide 114 and the punch holder 112 may be coupled to each other by a clamp or shank fastening method.

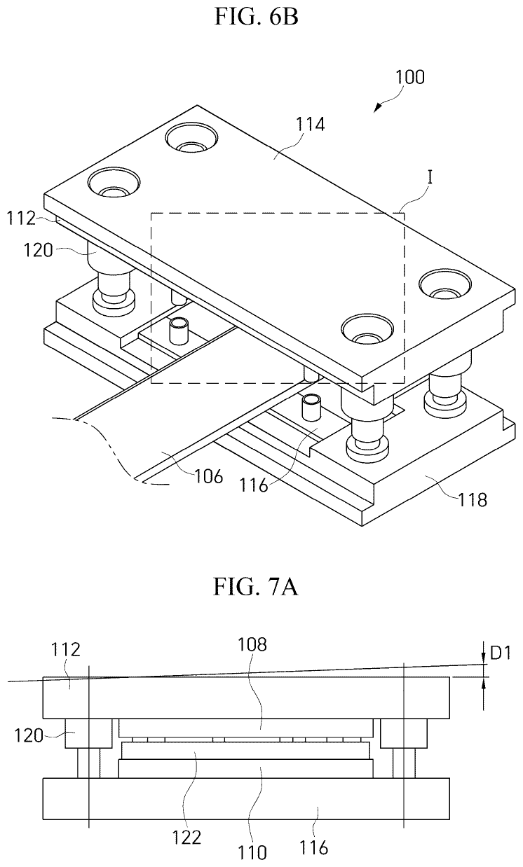

FIG. 7A is a vertical cross-sectional view of the press equipment for notching shown in FIG. 6B and illustrates a state in which the upper and lower slides 114 and 118 are removed and also illustrates a deviation in parallelism (e.g., a parallelism deviation). Here, reference numeral 122 denotes a stripper that separates the punched electrode plate.

Because the parallelism of the press equipment is not always uniform, parallelism of an electrode shearing (e.g., notching) die corresponds that of the press equipment, which makes it difficult to maintain uniform parallelism. Thus, the punch 102 cannot be vertically inserted into the die 104, which may cause problems in shear quality and damage to the punch and the die.

Because the upper part and the lower part should concurrently (or simultaneously) operate due to the characteristics of the press equipment, the press equipment is manufactured to be lightweight. As a result, it may be difficult to manufacture and modify the press equipment to sturdily and accurately maintain uniform parallelism. In addition, because parallelism may change randomly during equipment operation, the parallelism cannot be easily adjusted by applying a fixed correction method.

FIG. 7B illustrates an effect of a deviation of parallelism of the press equipment on the punch 102 and the die 104. The verticality (or vertical arrangement or orientation) of the punch 102 may change according to die parallelism. As shown in FIG. 7A, when parallelism of the upper part exhibits a deviation of D1, a deviation of the punch 102 may be D2. For example, when D1=40 μm, D2=4.7 μm, which not only affects a shape, area, etc. of an electrode plate but also causes quality-related problems, such as burrs remaining on a shear plane of the electrode plate and damage to the punch 102 and die 104, thereby causing serious damage and the like to surrounding members.

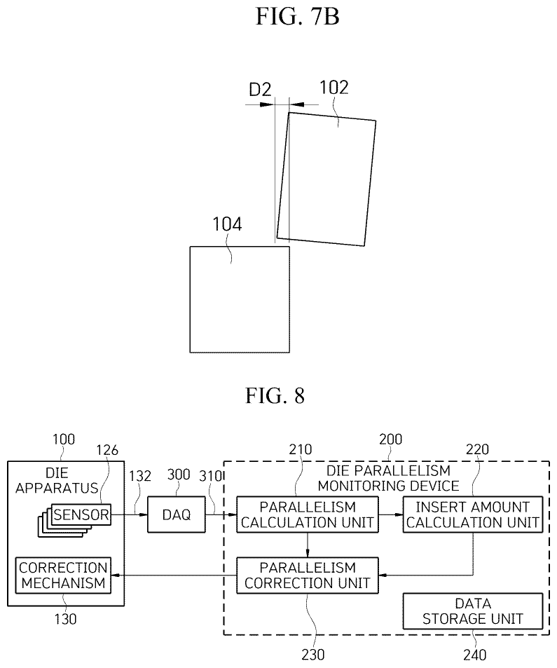

FIG. 8 is a schematic block diagram of a die parallelism monitoring device according to some embodiments of the present disclosure.

A distance measurement sensor 126 (e.g., a non-contact laser sensor, an eddy current sensor, an inductive displacement sensor, etc.) is installed in a die apparatus 100 as shown in, for example, FIG. 6B. The die apparatus 100 may include a correction mechanism 130 for correcting parallelism.

A data acquisition device (DAQ) 300 may transmit a current value output from a distance measurement sensor 126 to a die parallelism monitoring device 200. The DAQ may collect information from connected sensors or devices to measure and record electrical or physical quantities, such as voltage, current, temperature, strain, pressure, shock, vibration, distance, displacement, rpm, angle, weight, etc.

The die parallelism monitoring device 200 may include a parallelism calculation unit 210 that substitutes a sensor current value, which is downloaded, for example, as a comma separated value (CSV) file, through the DAQ 300 with, for example, an equation, to convert the sensor current value into a distance value to check (or monitor) die parallelism, a punch insert amount calculation unit 220 that calculates an insert amount of a punch 102 by using the converted distance value, and a parallelism correction unit 230 that enables the correction mechanism 130 of the die apparatus 100 to correct parallelism of the die apparatus 100 by using parallelism calculated by the parallelism calculation unit 210. In addition, the die parallelism monitoring device 200 may additionally include a data storage unit 240 that stores data to calculate the parallelism, calculate an insert amount, and correct the parallelism. Here, an insert amount is a technical term in the die field that refers to a depth to which a punch is lowered to a die.

Each of these components is described in more detail below.

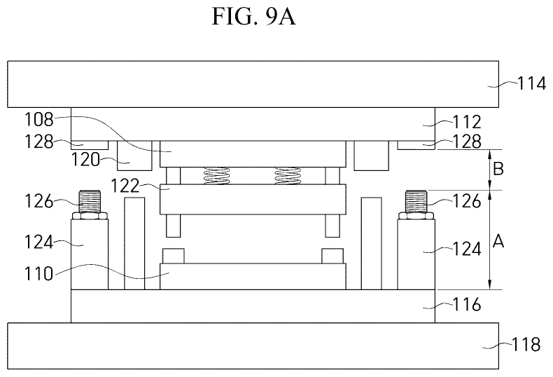

FIG. 9A is a vertical cross-sectional view illustrating the distance measurement sensor 126 installed in the die, and FIG. 9B is a plan view of the die holder 116.

In FIG. 9A, the distance measurement sensor 126 may be installed to protrude upwardly from an upper surface of the die holder 116 and may be installed at each of four points near the guide posts 120. In another embodiment, the distance measurement sensor 126 may be installed on a lower surface of the punch holder 112 (e.g., the distance measurement sensor 126 may be installed on the punch holder 112 to protrude downwardly). In FIG. 9A, a height of the distance measurement sensor 126 from the die holder 116 is indicated by A, and a distance between the sensor 126 and a measurement target surface 128 is indicated by B.

FIG. 9B is a plan view illustrating an embodiment in which the distance measurement sensor 126 is installed on the upper surface of the die holder 116. Four distance measurement sensors 126 are installed at positions near the guide posts 120 disposed at four corners of the die holder 116. In FIG. 9B, a pair of dies supported on the punch holder 112, that is, an electrode plate bottom die 109 and a tab die 111, are visible. Sensors at Point 1 and Point 2 are installed at the tab die 111, and sensors at Point 3 and Point 4 are installed at the bottom die 109.

As described above, the distance measurement sensor 126 is, in one embodiment, a non-contact sensor, such as a laser sensor, an eddy current sensor, an inductive displacement sensor, etc.

The distance measurement sensor 126 may be firmly fixed by using a sensor fixing block 124 attached to the die holder 116 or the punch holder 112. A measurement target surface 128 may be attached to a facing surface of the distance measurement sensor 126 to provide greater sensing precision compared to a surface of a material (e.g., aluminum) of the die holder 116 or punch holder 112. The measurement target surface 128 may be, for example, a steel plate (e.g., an S45C steel plate).

The distance measurement sensor 126 may output a current value corresponding to a distance to (or a distance from) the measurement target surface 128. As described above, the current value may be transmitted to the die parallelism monitoring device 200 through the DAQ device 300.

The die parallelism monitoring device 200 may be implemented with a dedicated program on a general-purpose computer but may also be implemented in another manner, for example, by dedicated, stand-alone hardware.

The parallelism calculation unit 210 in the die parallelism monitoring device 200 receives the current value of the distance measurement sensor 126. A format of received data may be a CSV file, but the present disclosure is not limited thereto. The parallelism calculation unit 210 may substitute the downloaded current value with an equation to convert the current value into a distance value and, thus, may calculate parallelism at a bottom dead point of a die by using the converted distance value.

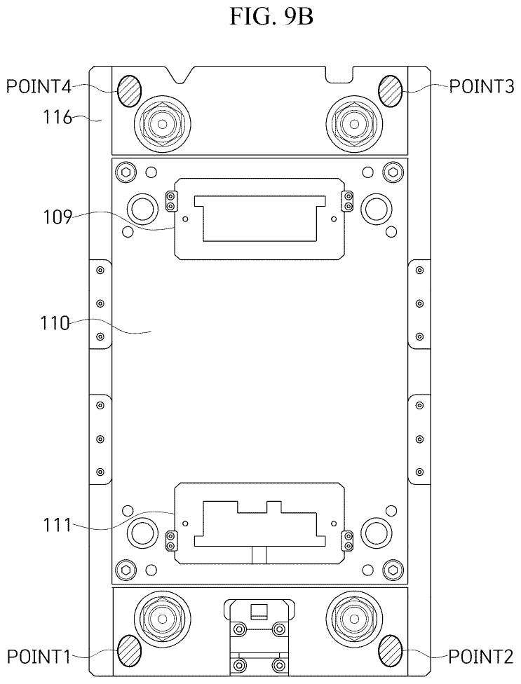

First, to convert a current value obtained by a sensor into a distance value, a current-distance graph or equation as shown in FIG. 10A is obtained. A method of obtaining the current-distance graph or equation is shown in FIG. 10B.

In FIG. 10B, in a state in which an upper die is lowered to a bottom point center (S10), a distance between the distance measurement sensor 126 and the measurement target surface 128 (e.g., the sensing distance shown in FIG. 9A, that is, the distance B between the distance measurement sensor 126 and the measurement target surface 128) is set to a specific value (S20). A current value of the distance measurement sensor 126 output by performing a punch at a speed of about 120 SPM is acquired (S30 and S40). Such a process is repeated N times by changing the sensing distance, and an average value of current values of the bottom point center acquired at each time is calculated and recorded as “average current value:sensing distance,” for example, in the data storage unit 240 (S50). By marking a dot of an average current value corresponding to each sensing distance, a graph indicated by three points may be drawn, and a linear equation as shown in FIG. 10A may be derived therefrom.

To increase the accuracy of the equation that is derived, in setting the sensing distance (S20), the sensing distance may be set differently to various distance values to repeatedly perform a punch. For example, after the sensing distance is set to intervals of, for example, 2 mm, 3 mm, 4 mm, and 5 mm to perform a test, the sensing distance may be subdivided into and set to, for example, 1.6 mm, 2.1 mm, and 2.6 mm again.

Next, a process of calculating parallelism at the bottom point center of the die by using the converted distance value is described.

A distance (e.g., B in FIG. 9A) between each distance measurement sensor 126 and the corresponding measurement target surface 128 is obtained (e.g., the distance may be obtained by converting a sensor current value into a distance value by using an equation as described above), and a distance P1 of Point 1 is set to 0. Relative values P2 to P4 of Point 2 to Point 4 may be calculated to calculate parallelism.

For example, a calculation formula of P=A+B may be used. Here, P denotes a distance between the punch holder and the die holder at each of Point 1 to Point 4 at corners of the die, A denotes a sensor height in FIG. 9A, which may be measured by using a measurement instrument, such as a height gauge, and B denotes a distance between the sensor and the punch holder in FIG. 9A, which is a distance value converted from a sensor current value.

Therefore, because P1=A1+B1, P2=A2+B2, P3=A3+B3, and P4=A4+B4, a P value at each of the four points may be calculated to calculate parallelism.

The punch insert amount calculation unit 220 calculates an insert amount, which represents a degree by which the punch is lowered to the die. A punch insert amount of a notching die may be measured by using the distance measurement sensor 126 and calculated as a difference between a distance between an upper die holder and a lower die holder when a punch insert amount is 0 and a distance between the distance measurement sensor 126 and the measurement target surface 128. For example, height values, that is, the P1 to P4 values, may be measured by using the distance measurement sensor 126 installed at each point, and then, an insert amount may be calculated in real time by comparing intervals between the upper die holder and the lower die holder when an insert amount is 0.

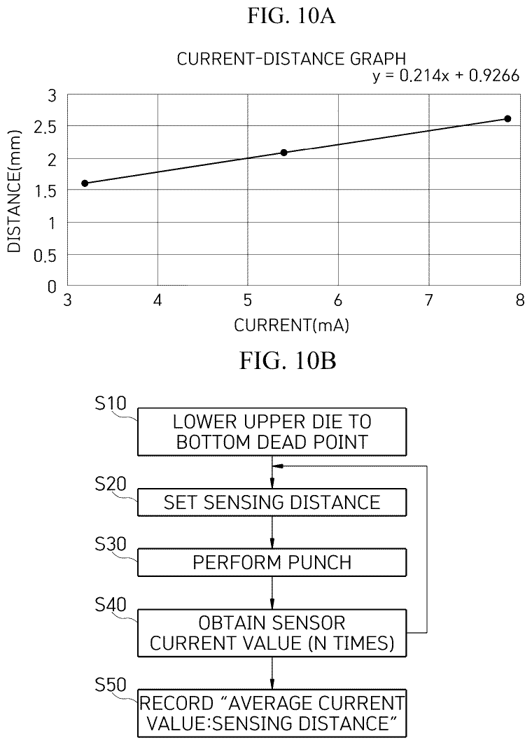

For example, referring to FIG. 11A, [(tap punch insert amount)=(distance between upper die holder and lower die holder when insert amount is 0)−(average of P1 and P2)] and [(bottom punch insert amount)=(distance between upper die holder and lower die holder when insert amount is 0)−(average of P3 and P4)]. For example, referring to FIG. 11A, when a distance H between the upper die holder and the lower die holder=78.9 mm when an insert amount is 0, and when a tap punch insert amount c=0.2 mm, P1=78.71 mm, and P2=78.69 mm, the insert amount may be calculated as insert amount of 0.2 mm (=[78.9 mm−(78.71 mm+78.69 mm)]/2).

The parallelism correction unit 230 is described in more detail below.

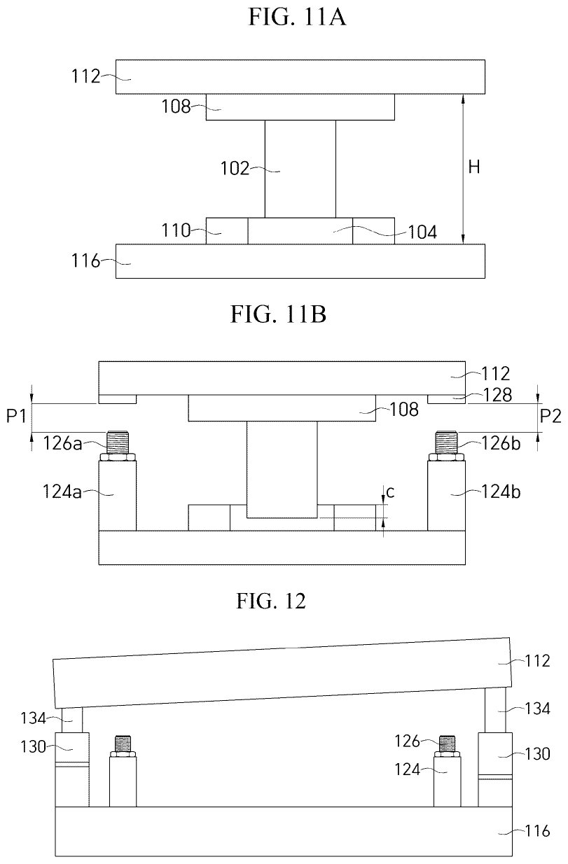

To correct parallelism, the correction mechanism 130 may be installed at each of four corners of a notching die as shown in, for example, FIG. 12. The correction mechanism 130 may include a sliding cylinder 134 using a medium, such as pneumatic pressure, hydraulic pressure, gas, etc.

In some embodiments, the parallelism correction unit 230 of the die parallelism monitoring device 200 may analyze parallelism values calculated by each distance measurement sensor 126 and may generate a control signal for controlling the correction mechanism 130 to operate the correction mechanism 130 to correct parallelism of an die. In another embodiment, a control system for controlling the correction mechanism 130 may be constructed at the notching die, and the parallelism correction unit 230 of the die parallelism monitoring device 200 may transmit a correction command signal together with correction data.

Conventionally, because parallelism of a die has been measured manually by a worker, it takes time to perform the measurement, and mistakes may occur. In addition, because measurement is only possible when press equipment is stopped, it is not possible to monitor parallelism in real time during punching. Thus, there are problems, such as damage to a die, poor electrode quality, increased maintenance costs, and decrease production.

According to embodiments of the present disclosure, degradation of parallelism of a die can be monitored during production of an electrode. By using an automatic parallelism correction mechanism, damage to a die can be prevented, and electrode quality can be improved. In addition, an insert amount can be calculated by using a distance value measured using a sensor, thereby preventing mistakes when setting an insert amount before punching and checking (or determining) an insert amount in real time during production.

In summary, by monitoring die parallelism in embodiments of the present disclosure, parallelism can be monitored in real time through automation of parallelism measurement, and thus, degradation of die parallelism can be detected in real time, thereby preventing damage to a die in advance. Parallelism of a die can be measured by using a distance measurement sensor to eliminate the need for manual work of a worker, thereby reducing measurement time and preventing mistakes. In addition, parallelism measurement and correction are possible even during a punching operation. An insert amount of a die can be calculated, thereby preventing errors in setting an initial insert amount. In sum, according to embodiments of the present disclosure, maintenance costs of electrode plate manufacturing equipment can be reduced while production can be increased.

Aspects and features of the present disclosure are not limited to those described above, and other aspects and features not specifically mentioned herein will be clearly understood by those skilled in the art from the description of the present disclosure below.

Although the present disclosure has been described above with respect to embodiments thereof, the present disclosure is not limited thereto. Various modifications and variations can be made thereto by those skilled in the art within the spirit of the present disclosure as defined by the appended claims and their equivalents.

What is claimed is:

1. A secondary battery electrode plate manufacturing apparatus comprising:
a distance measurement sensor installed in a die and configured to output a sensor output value;
a parallelism calculation unit configured to convert the sensor output value into a distance value to determine parallelism of the die; and
a punch insert amount calculation unit configured to calculate a punch insert amount by using the converted distance value.

2. The secondary battery electrode plate manufacturing apparatus as claimed in claim 1, further comprising:
a parallelism correction mechanism installed in the die; and
a parallelism correction unit configured to control the parallelism correction mechanism to correct the parallelism of a die apparatus by using the parallelism calculated by the parallelism calculation unit.

3. The secondary battery electrode plate manufacturing apparatus as claimed in claim 2, wherein the parallelism correction unit is configured to analyze a parallelism value calculated by the parallelism calculation unit and to generate a control signal for controlling the parallelism correction mechanism to operate the parallelism correction mechanism to correct the parallelism of the die.

4. The secondary battery electrode plate manufacturing apparatus as claimed in claim 2, wherein the parallelism correction unit is configured to transmit a correction command together with correction data to the parallelism correction mechanism of the die.

5. The secondary battery electrode plate manufacturing apparatus as claimed in claim 1, wherein the distance measurement sensor is installed on an upper surface of a die holder of the die.

6. The secondary battery electrode plate manufacturing apparatus as claimed in claim 1, wherein the distance measurement sensor is installed on a lower surface of a punch holder of the die.

7. The secondary battery electrode plate manufacturing apparatus as claimed in claim 1, wherein the distance measurement sensor is a non-contact sensor.

8. The secondary battery electrode plate manufacturing apparatus as claimed in claim 1, further comprising a measurement target surface attached to a surface of the die facing the distance measurement sensor.

9. The secondary battery electrode plate manufacturing apparatus as claimed in claim 1, wherein the distance measurement sensor outputs a current value, and
wherein the parallelism calculation unit is configured to convert the current value into a distance value.

10. The secondary battery electrode plate manufacturing apparatus as claimed in claim 9, wherein the parallelism calculation unit is configured to use a current-distance equation to convert the current value into the distance value.

11. The secondary battery electrode plate manufacturing apparatus as claimed in claim 1, wherein the parallelism calculation unit is configured to calculate the parallelism by using an interval between a punch holder and a die holder of the die, a height of the distance measurement sensor, and a distance between the distance measurement sensor and a corresponding measurement surface.

12. The secondary battery electrode plate manufacturing apparatus as claimed in claim 1, wherein the punch insert amount calculation unit is configured to calculate the punch insert amount according to a difference between a distance between an upper holder and a lower holder when an insert amount is 0 and a distance between the distance measurement sensor and a corresponding measurement surface.

13. A secondary battery electrode plate manufacturing method comprising:
a parallelism calculation operation comprising converting an output value of a distance measurement sensor installed in a die into a distance value to determine parallelism of the die; and
a punch insert amount calculation operation comprising calculating a punch insert amount by using the converted distance value.

14. The secondary battery electrode plate manufacturing method as claimed in claim 13, further comprising a parallelism correction operation comprising correcting the parallelism of the die by using the calculated parallelism.

15. The secondary battery electrode plate manufacturing method as claimed in claim 13, wherein the distance measurement sensor outputs a current value, and
wherein the parallelism calculation operation further comprises converting the current value into a distance value.

16. The secondary battery electrode plate manufacturing method as claimed in claim 15, wherein the parallelism calculation operation further comprises using a current-distance equation to convert the current value into the distance value.

17. The secondary battery electrode plate manufacturing method as claimed in claim 13, wherein the parallelism calculation operation further comprises calculating the parallelism by using an interval between a punch holder and a die holder of the die, a height of the distance measurement sensor, and a distance between the distance measurement sensor and a corresponding measurement surface.

18. The secondary battery electrode plate manufacturing method as claimed in claim 13, wherein the punch insert amount calculation operation further comprises calculating a punch insert amount according to a difference between a distance between an upper holder and a lower holder when an insert amount is 0 and a distance between the distance measurement sensor and a corresponding measurement surface.

19. The secondary battery electrode plate manufacturing method as claimed in claim 14, wherein the parallelism correction operation further comprises analyzing a parallelism value calculated in the parallelism calculation operation and generating a control signal for controlling the parallelism of the die to transmit the control signal to the die.

20. The secondary battery electrode plate manufacturing method as claimed in claim 14, wherein the parallelism correction operation further comprises transmitting a correction command together with correction data to the die.
